(19) United States
(12) Patent Application Publication
(10) Pub. No.: US 2017/0325637 A1
(43) Pub. Date: Nov. 16, 2017

(54) COOKING UTENSIL

(71) Applicants: Keith Louis Featherstone CRONWRIGHT, CAPE TOWN (ZA); Sarah-May STEENKAMP, Cape Town (ZA)

(72) Inventor: Keith Louis Featherstone CRONWRIGHT, CAPE TOWN (ZA)

(21) Appl. No.: 15/523,255

(22) PCT Filed: Oct. 28, 2015
(86) PCT No.: PCT/IB2015/058297

§ 371 Date: Apr. 28, 2017

(30) Foreign Application Priority Data
Oct. 28, 2014 (ZA) 2014/07839

(51) Int. Cl. A47J 43/18; A47J 37/10; A47J 37/07

(52) U.S. Cl. CPC A47J 43/18; A47J 37/0786; A47J 37/108

(57) ABSTRACT

A cooking utensil which comprises walling defining an upwardly open compartment having two side walls which are elongate in the vertical direction and in one horizontal direction. The distance between the side walls is less than the dimensions in the vertical and horizontal directions thereby to provide a food receiving compartment which is relatively long and relatively high but is also relatively narrow. To provide a number of parallel side-by-side compartments the utensil (64) comprises a bounding wall including two spaced apart sidewall sections (66). One or more partitions (70) extend parallel to the sidewall sections (66) and span between side wall sections (68) thereby to define a number of such compartments.

### FIELD OF THE INVENTION

This invention relates to a cooking utensil.

### BACKGROUND TO THE INVENTION

Some cuts of meat including chops and steaks have a layer of fat along part of their edge. It is desirable for the fat to be well cooked, or browned, and this is difficult to achieve if the chop or steak is lying flat in a frying pan or on a barbeque grid. Having the fat well-cooked or browned, and having the meat rare or “bleu”, is even more difficult to achieve.

An object of the present invention is to provide a cooking utensil which facilitates the cooking of a rim of fat along the edge of a cut of meat before, or if desired after, the flat surfaces of the chop or steak have been cooked whilst lying flat in a cooking pan or on a barbeque grid.

### BRIEF DESCRIPTION OF THE INVENTION

According to one aspect of the present invention there is provided a cooking utensil which comprises walling defining an upwardly open compartment having two side walls which are elongate in the vertical direction and in one horizontal direction and the distance between which is less than the dimensions in the vertical and horizontal directions thereby to provide a food receiving compartment which is relatively long and relatively high but is also relatively narrow.

The cooking utensil preferably comprises a bounding wall including two spaced apart sidewall sections and one or more partitions extending parallel to said sidewall sections thereby to define at least two of said compartments which lie parallel to one another and are side-by-side. In this form the utensil can comprise a wire basket, the partition or partitions spanning between opposed side walls of said basket.

The, or each, partition is preferably in the form of a wire grid and in one form the utensil can have three parallel partitions so as to provide, with said sidewall sections, four compartments which are parallel to one another and are side by side.

Adjacent partitions can be constituted by a wire grid which is bent along two parallel lines thereby to form two spaced apart parallel partitions joined by a base wall.

Said compartments can be open at their top and bottom and said bounding wall can include two outwardly curved sections which join the ends of the sidewall sections, the partition or partitions spanning between said curved sections.

The utensil can include a handle protruding from said bounding wall, said handle having a gripping part and a bar which joins the gripping part to said bounding wall, said gripping part and said bounding wall extending downwardly below said bar and there being a downwardly open below the bar and between said gripping part and said wall.

The handle can be pivotally mounted and can move between a protruding in use position and an inoperative, stored position in which it lies against the outer surface of said bounding wall. In a specific form said handle comprises two handle parts which are pivotal independently of one another and in opposite directions so that they lie against outer surfaces of opposed parts of said bounding wall.

According to a further aspect of the present invention there is provided tongs for use in lifting food, the tongs comprising a pair of arms which are spring-loaded with respect to one another to an open position and which have food gripping plates mounted thereon, the food gripping plates being capable of pivotal movement with respect to the arms so as to enable them to adjust to the contours of any item of food that is being lifted. The axes about which the gripping plates can pivot are desirably at right angles to the longitudinal axes of the arms.

In a specific constructional form there are rods which form extensions of said arms and have right angled bends therein whereby each rod has two limbs which lie at right angles to one another, one limb of each rod constituting an extension of the respective arm and the gripping plates being pivotally mounted on the other limbs for rotation with respect thereto about the axes of said other limbs.

The surfaces of the gripping plates which face one another can be serrated to assist in gripping the item of food being lifted

### BRIEF DESCRIPTION OF THE DRAWINGS

For a better understanding of the present invention, and to show how the same may be carried into effect, reference will now be made, by way of example, to the accompanying drawings in which,

FIG. 1 is a pictorial view of a cooking utensil in accordance with the present invention;

FIG. 2 is a pictorial view of the utensil of FIG. 1 with the handle in a stored, inoperative condition;

FIG. 3 is a diagrammatic pictorial view of part of the utensil of FIGS. 1 and 2;

FIG. 4 is a pictorial view of a further cooking utensil according to the present invention;

FIG. 5 is a pictorial view of the utensil of FIG. 4 with the handle in a stored, inoperative condition;

FIG. 6 is a pictorial view of a pair of tongs;

FIG. 7 is a plan view of the tongs of FIG. 6;

FIG. 8 is a front elevation of one of the gripping plates of the tongs of FIGS. 6 and 7;

FIG. 9 is a side elevation of the gripping plate of FIG. 8;

FIG. 10 illustrates the use of the tongs of FIGS. 6 to 9 in conjunction with the utensil of FIGS. 4 and 5;

FIG. 11 illustrates a further utensil in accordance with the present invention;

FIG. 12 is a view identical to that of FIG. 11 and which additionally shows a handle;

FIG. 13 is a side elevation of the utensil of FIGS. 11 and 12, and

FIG. 14 is a side view identical to that of FIG. 13 and which also shows a frying pan.

### DETAILED DESCRIPTION OF THE DRAWINGS

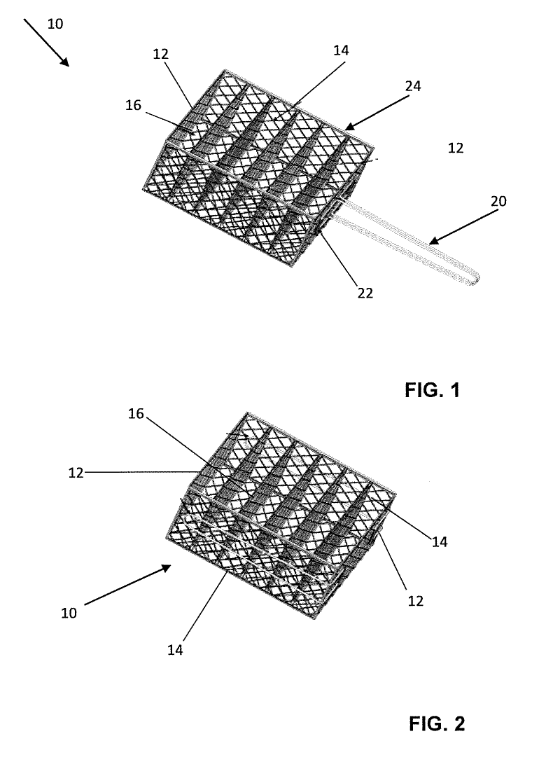

The cooking utensil 10 illustrated in FIGS. 1 and 2 is in the form of a wire basket which is rectangular in plan view and comprises four vertical side walls 12, 14 and a base 16. Within the space bounded by the side walls 12, 14 there are vertical, parallel partitions 18 each of which is in the form of a wire grid. The partitions divide the space bounded by the side walls 12, 14 into a number of compartments for receiving food.

Each compartment is elongate in one horizontal direction, that is, in the direction of the lengths of the partitions 18, elongate in the vertical direction and relatively narrow in the other horizontal direction, that is, in the direction transverse to the direction in which the partitions 18 are elongate.

A two part handle 20 is shown in FIG. 1. The handle parts are pivotally mounted on one of the side walls 12 and extend outwardly from that side wall 12. The configuration of the handle 20 and the mounting of the handle parts is such that each handle part can be pivoted about a vertical mounting axis to a position in which it lies against the adjacent wall 14 as shown in FIG. 2.

The upper edges of the walls 12 and 14 can be attached to a bounding wire 24.

The utensil 10 can be placed on a barbeque grid. Steaks and chops can be placed in a vertical position in the compartments with the fat which is found along the edge of some steaks and chops against the base 16 and hence directly exposed to the heat. Once it is considered that the fat is sufficiently cooked and/or browned, the steaks and chops can be removed from the compartments and placed flat on the grid for further cooking.

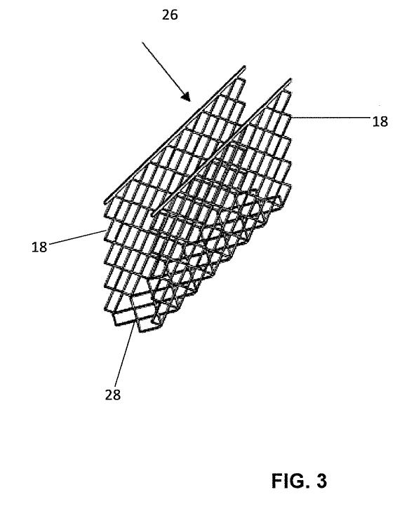

In FIG. 3 an insert 26 is illustrated. This provides two of the partitions 18 and is placed in the space bounded by the walls 12, 14. The partitions 18 of the insert 26 are joined along their lower edges by a base wall 28 which rests on the base 16.

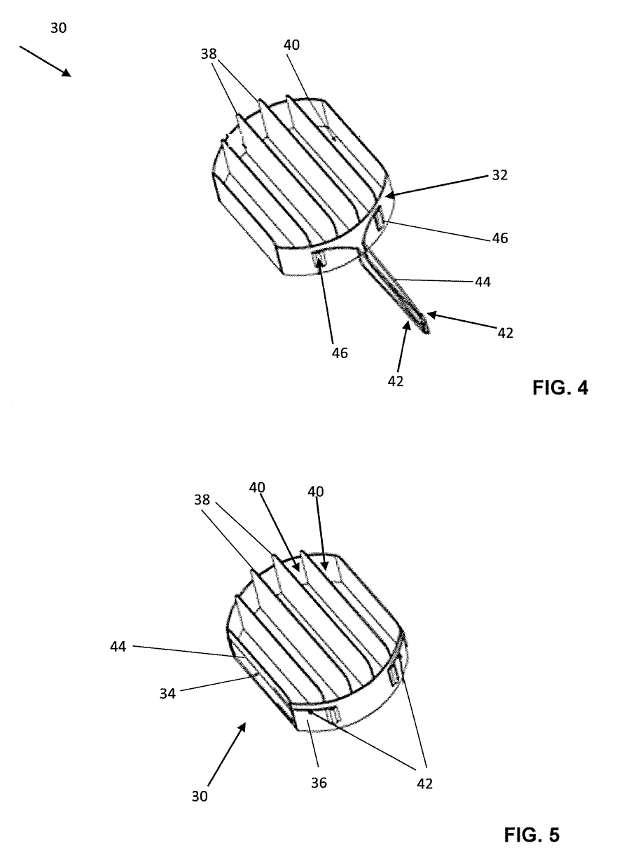

Turning now to FIGS. 4 and 5, the utensil 30 illustrated comprises a bounding wall 32 constituted by two parallel planar sections 34 and two curved sections 36. Partitions 38 span between the sections 36 and are parallel with the sections 34. This configuration provides five compartments 40 which are elongate in one horizontal direction and narrow in the transverse direction. The compartments are open at their upper and lower ends.

A handle is provided which comprises two handle parts 42. Each handle part 42 includes an elongate gripping portion 44 and a vertical portion which lies in a vertically extending socket 46. The handle parts 42 can be pivoted, about the vertical axes of the sockets, to the stored inoperative positions of FIG. 5 where they lie against the wall sections 34.

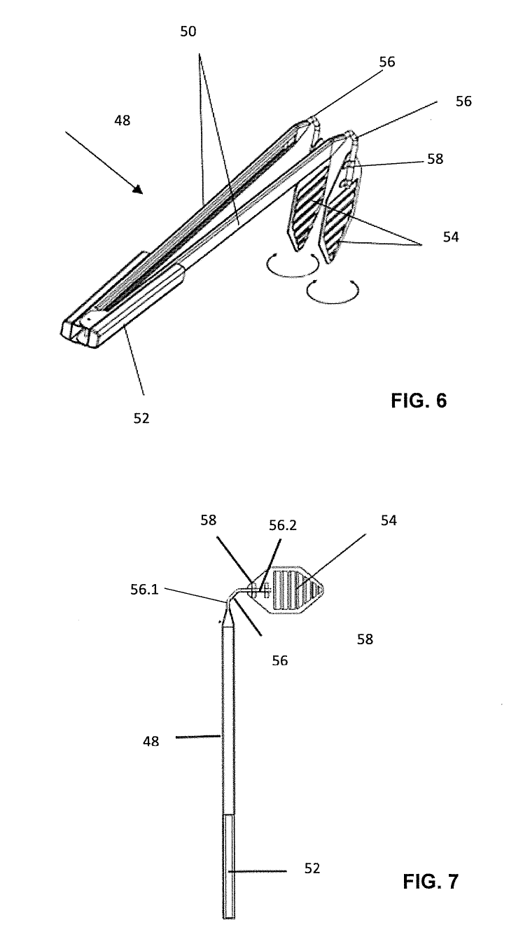

The tongs 48 illustrated in FIGS. 6 and 7 comprises two arms 50 which are connected to one another at one end and between which there is a spring which forces the arms 50 apart. Alternatively the arms can be of spring steel with a U-bend in it which joins the arms. Wooden handles 52 are secured to the arms 50 to facilitate gripping of the tongs.

A food gripping plate 54 is provided at the end of each arm 50 remote from the handle 52. The gripping plates 54 are secured to the arms 50 by means of rods 56. Each rod 56 has a right angled bend in it to provide two limbs 56.1 and 56.2. The limbs 56.1 of the rods 56 are connected to a respective one of the arms 50. The limbs 56.2 pass through mountings 58 secured to the plate 54. The limbs 56.2 are free to rotate in the mountings 58, so that the plates 54 can swivel about the axes of the mountings 58 as shown by the circular arrows in FIG. 6.

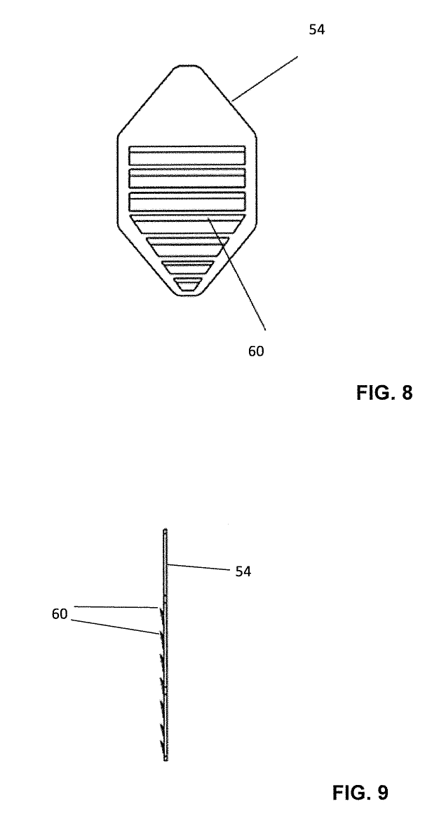

The plates 54 are formed with serrations 60 (FIGS. 8 and 9) which prevent a food item from slipping down when gripped by the plates. The ability of the plates 54 to rotate about the axes of the limbs 56.1 enables them to adjust to the shape of the steak or chop which is being picked-up.

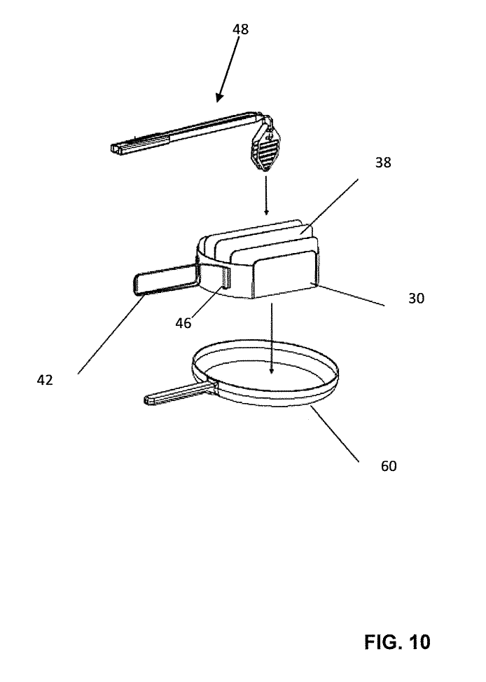

In FIG. 10 the utensil 30 is shown before it is placed in a frying pan 62. The tongs 48 are shown in the position to place a cut of meat such as a chop or piece of steak into one of the compartments 40 so that it rests on the top surface of the frying pan 62 and is held in an upright position.

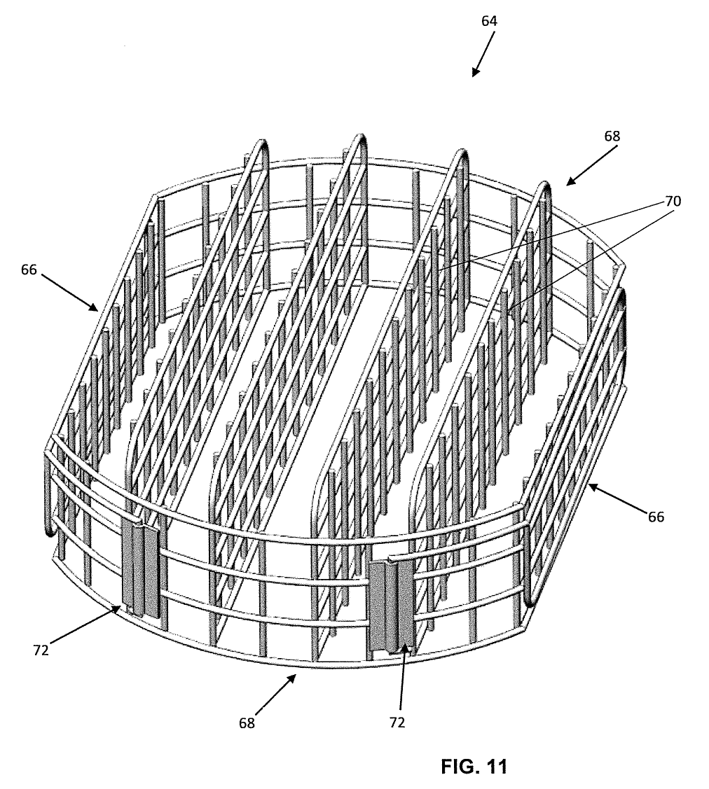

The utensil 64 of FIGS. 11 to 14 has substantially the same shape as the utensil of FIGS. 4 and 5 but is constructed using wire instead of flat, unapertured plates. The side wall of the utensil 64 comprise opposed straight sections 66 and outwardly curving end sections 68. Four partitions 70 span between the sections 68 and are parallel to the sections 66.

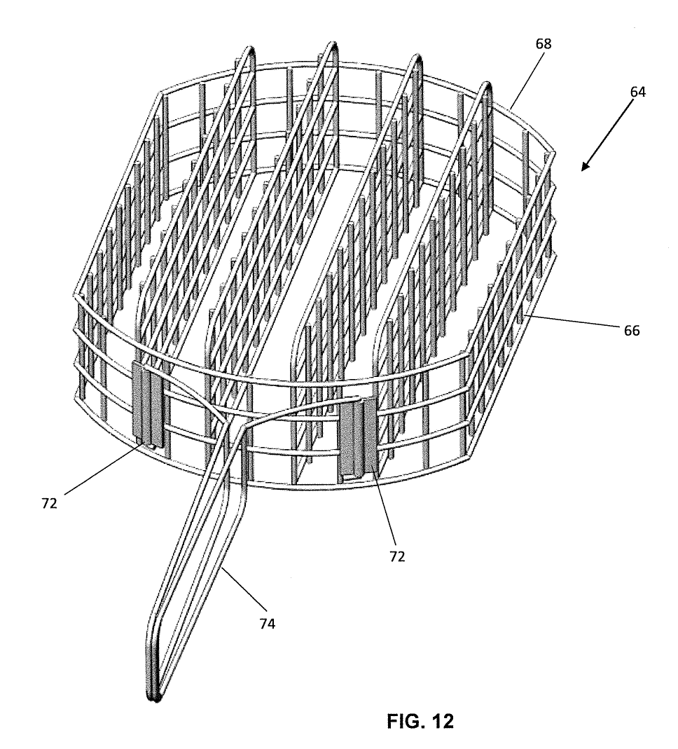

Two mountings 72 for a two part handle 74 (FIG. 12) are secured to one of the wall sections 68. The handle 74 is of the same form as described above and the parts can be swung outwardly away from one another to stored positions against the wall sections 66.

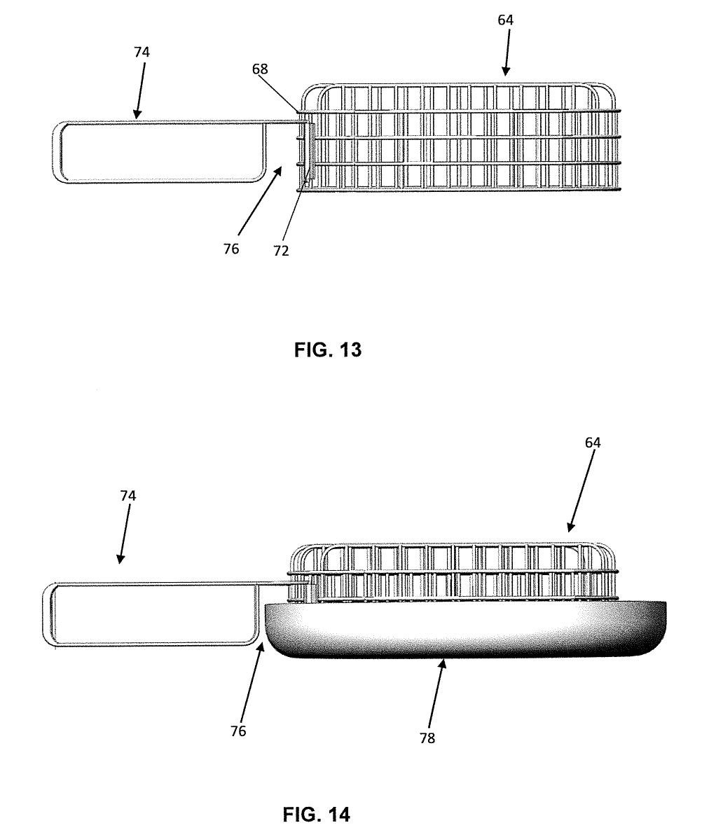

It will be noted from FIG. 13 that the handle is configured so that it has a gripping part and a bar which joins the gripping part to the wall. There is a downwardly open gap 76 which is below the bar and is between the section 68 and the main part of the handle. This receives the rim of a frying pan 78 (see FIG. 14) when the utensil 64 is placed in it.

1. A cooking utensil which comprises walling defining an upwardly open compartment having two side walls which are elongate in the vertical direction and in one horizontal direction and the distance between which is less than the dimensions in the vertical and horizontal directions thereby to provide a food receiving compartment which is relatively long and relatively high but is also relatively narrow.

2. A cooking utensil as claimed in claim 1, and which comprises a bounding wall including two spaced apart sidewall sections and one or more partitions extending parallel to said sidewall sections thereby to define at least two of said compartments which lie parallel to one another and are side-by-side.

3. A cooking utensil as claimed in claim 2 and which is in the form of a wire basket, the partition or partitions spanning between opposed side walls of said basket.

4. A cooking utensil as claimed in claim 3, wherein the, or each, partition is in the form of a wire grid.

5. A cooking utensil as claimed in claim 2 and comprising three parallel partitions so as to provide, with said sidewall sections, four compartments which are parallel to one another and are side by side.

6. A cooking utensil as claimed in claim 2 in which adjacent partitions are constituted by a wire grid which is bent along two parallel lines thereby to form two spaced apart parallel partitions joined by a base wall.

7. A cooking utensil as claimed in claim 2, in which said compartments are open at their top and bottom.

8. A cooking utensil as claimed in claim 7, wherein said bounding wall includes two outwardly curved sections which join the ends of the sidewall sections, the partition or partitions spanning between said curved sections.

9. A cooking utensil as claimed in claim 2 and which includes a handle protruding from said bounding wall, said handle having a gripping part and a bar which joins the gripping part to said bounding wall, said gripping part and said bounding wall extending downwardly below said bar and there being a downwardly open gap below the bar and between said gripping part and said wall.

10. A cooking utensil as claimed in claim 2 and which comprises a handle that is pivotally mounted and which can move between a protruding in use position and an inoperative, stored position in which it lies against the outer surface of said bounding wall.

11. A cooking utensil as claimed in claim 9, wherein said handle comprises two handle parts which are pivotal independently of one another and in opposite directions so that they lie against outer surfaces of opposed parts of said bounding wall.

12-16. (canceled)
